(19) United States
(12) Patent Application Publication
(10) Pub. No.: US 2003/0041510 A1
(43) Pub. Date: Mar. 6, 2003

(54) Gardening ornament frame

(76) Inventor: Chen-Hsiung Lin, Taichung (TW)

Correspondence Address: Chen-Hsiung Lin, 58, MA YUAN WEST ST., TAICHUNG, TW

(21) Appl. No.: 09/950,355

(22) Filed: Sep. 5, 2001

(51) Int. Cl. A01G 17/06; A01G 17/14; A01G 7/00

(52) U.S. Cl. 47/4

(57) ABSTRACT

A gardening ornament frame has a first half netting, a second half netting engaging with the first half netting, a first hollow leg disposed on a bottom of the first half netting, and a second hollow leg disposed on a bottom of the second half netting. The first half netting has a first periphery. The second half netting has a second periphery. The first hollow leg has a first bottom opening. The second hollow leg has a second bottom opening.

### BACKGROUND OF THE INVENTION

The present invention relates to a gardening ornament frame. More particularly, the present invention relates to a gardening ornament frame which confines a plurality of plants in the gardening ornament frame.

Some gardening plants are cut into animal shapes. However, the gardening plants will grow up so that the animal shapes will be deformed.

### SUMMARY OF THE INVENTION

An object of the present invention is to provide a gardening ornament frame which confines a plurality of plants in the gardening ornament frame.

Accordingly, a gardening ornament frame comprises a first half netting, a second half netting engaging with the first half netting, a first hollow leg disposed on a bottom of the first half netting, and a second hollow leg disposed on a bottom of the second half netting. The first half netting has a first periphery. The second half netting has a second periphery. The first hollow leg has a first bottom opening. The second hollow leg has a second bottom opening.

### BRIEF DESCRIPTION OF THE DRAWINGS

FIG. 1 is a perspective assembly view of a gardening ornament frame of a first preferred embodiment in accordance with the present invention;

FIG. 1A is a perspective view of a bottom opening of a leg of a first preferred embodiment in accordance with the present invention;

FIG. 2 is a perspective exploded view of a gardening ornament frame of a first preferred embodiment in accordance with the present invention;

FIG. 3 is a schematic view illustrating an application of a gardening ornament frame of a first preferred embodiment in accordance with the present invention;

FIG. 4 is a perspective assembly view of a gardening ornament frame of a first preferred embodiment in accordance with the present invention;

FIG. 4A is a perspective view of a bottom opening of a leg of a first preferred embodiment in accordance with the present invention;

FIG. 5 is a perspective exploded view of a gardening ornament frame of a first preferred embodiment in accordance with the present invention; and

FIG. 6 is a schematic view illustrating an application of a gardening ornament frame of a first preferred embodiment in accordance with the present invention.

### DETAILED DESCRIPTION OF THE INVENTION

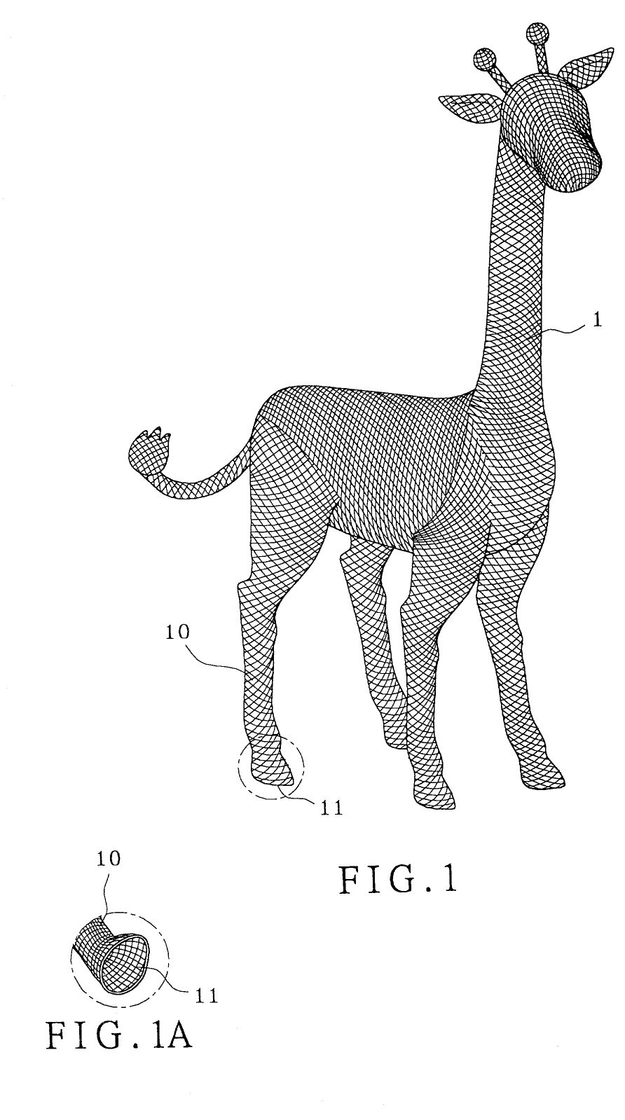

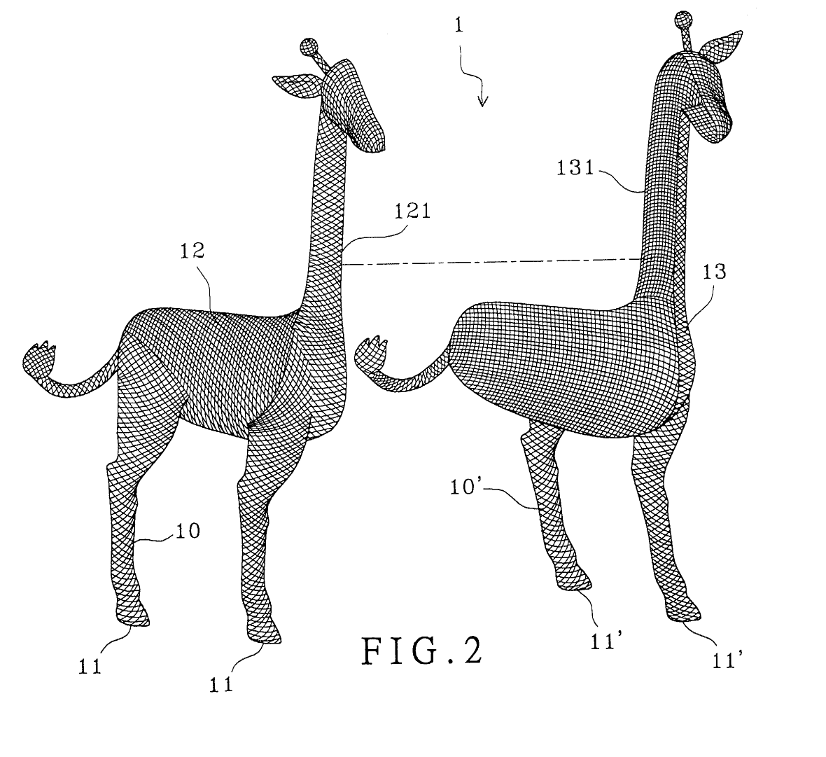

Referring to FIGS. 1 to 3, a first gardening ornament frame 1 comprises a first half netting 12, a second half netting 13 engaging with the first half netting 12, a plurality of first hollow legs 10 disposed on a bottom of the first half netting 12, and a plurality of second hollow legs 101 disposed on a bottom of the second half netting 13.

The first half netting 12 has a first periphery 121.

The second half netting 13 has a second periphery 131.

Each of the first hollow legs 10 has a first bottom opening 11.

Each of the second hollow legs 10′ has a second bottom opening 11′.

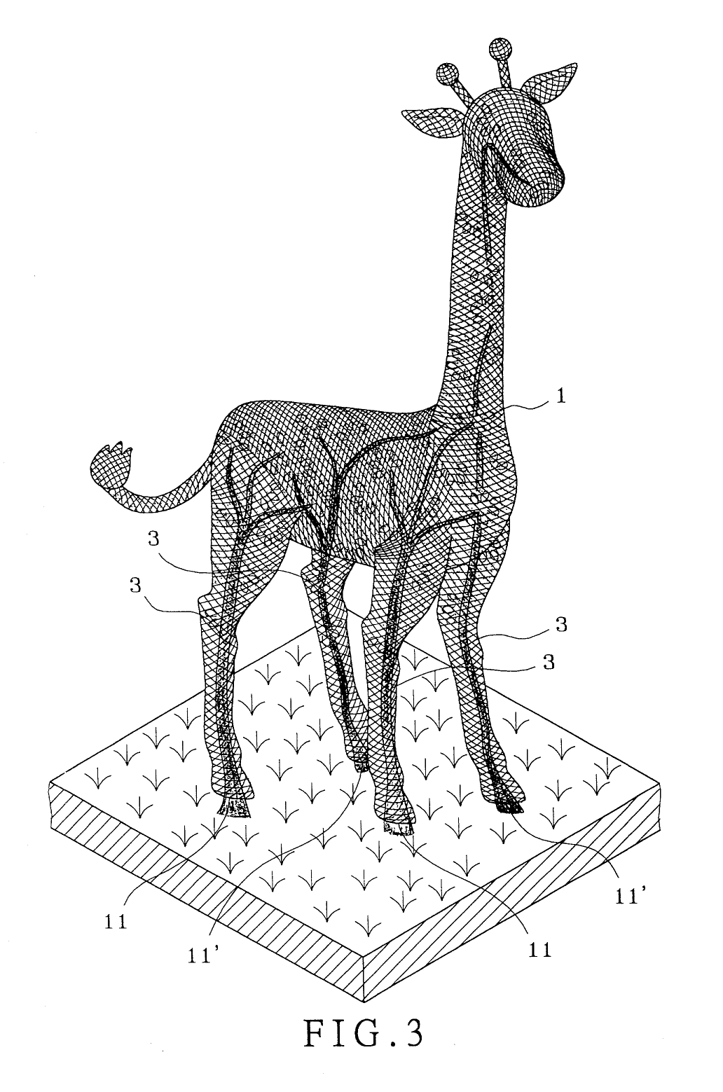

Referring to FIG. 3 again, a plurality of plants 3 are inserted in the first hollow legs 10 and the second hollow legs 10′. The plants 3 are confined in the first gardening ornament frame 1.

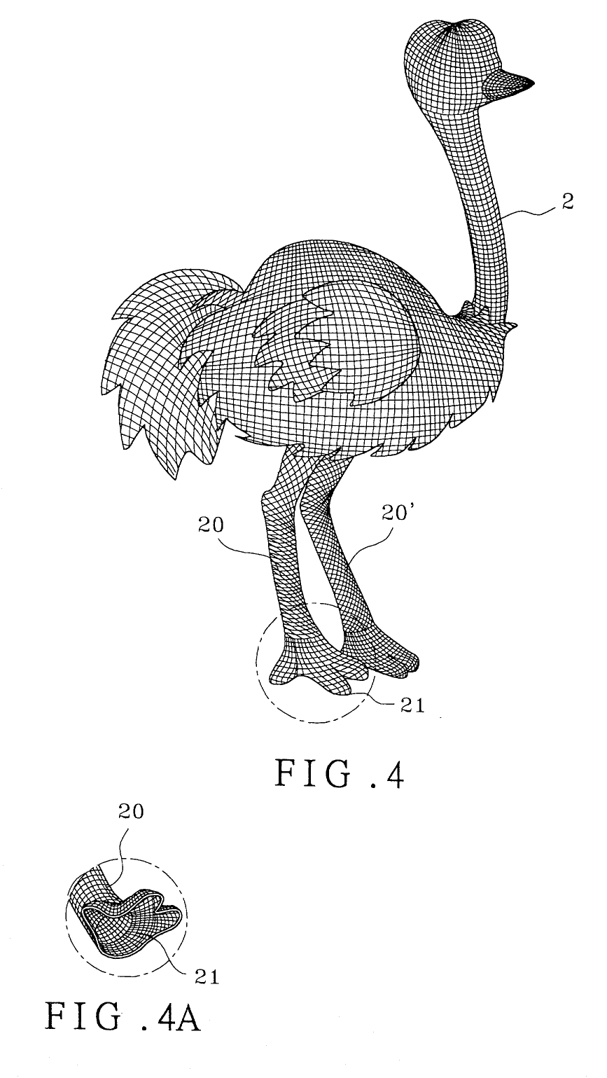

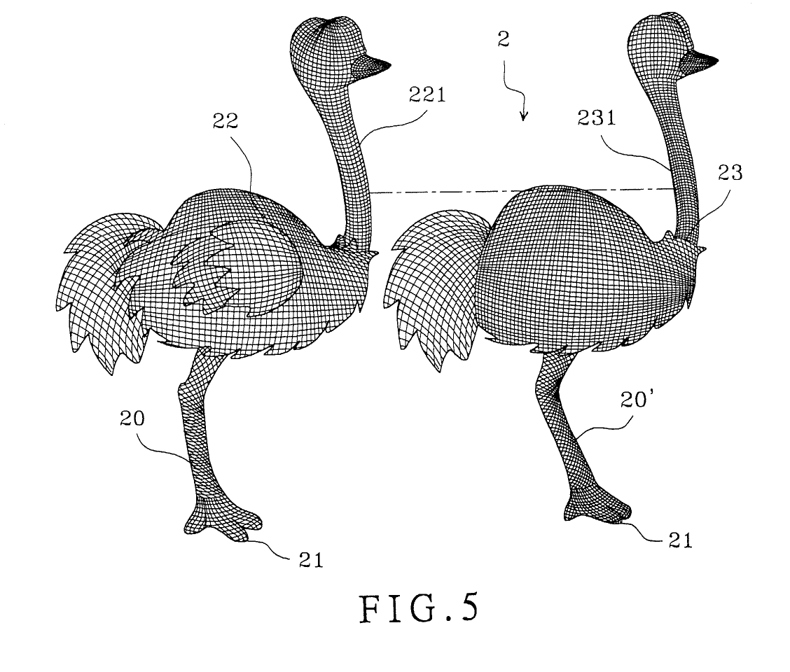

Referring to FIGS. 4 to 6, a second gardening ornament frame 2 comprises a first half netting 22, a second half netting 23 engaging with the first half netting 22, a first hollow leg 20 disposed on a bottom of the first half netting 22, and a second hollow leg 20′ disposed on a bottom of the second half netting 23.

The first half netting 22 has a first periphery 221.

The second half netting 23 has a second periphery 231.

The first hollow leg 20 has a first bottom opening 21.

The second hollow leg 20′ has a second bottom opening 21′.

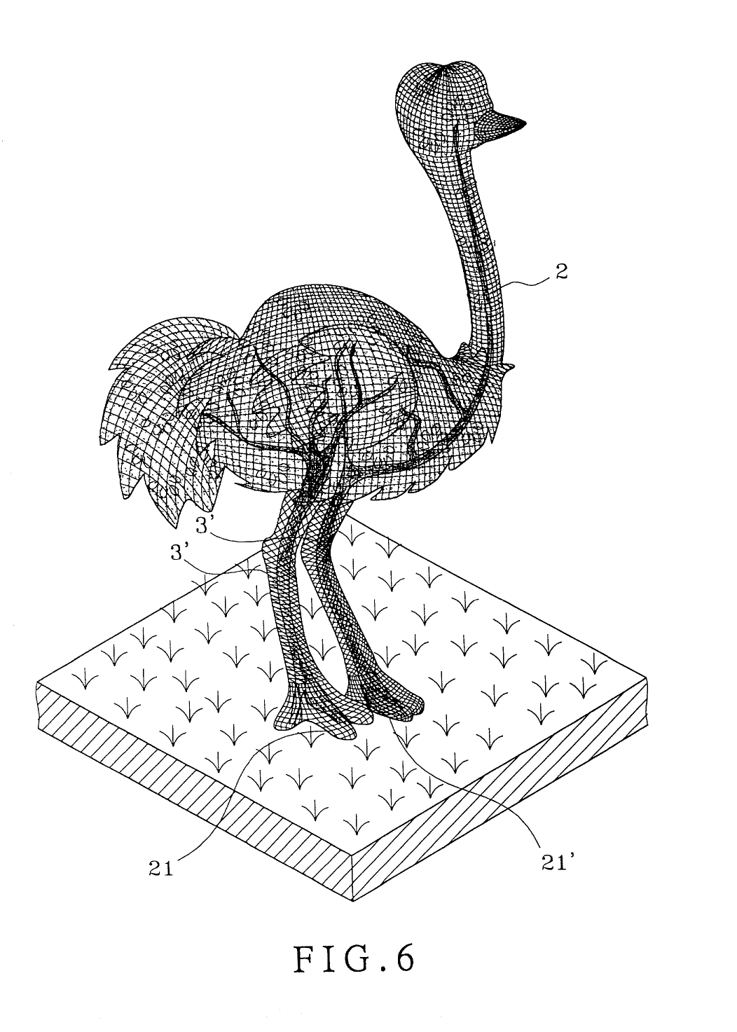

Referring to FIG. 6 again, a plurality of plants 3′ are inserted in the first hollow leg 20 and the second hollow leg 20′. The plants 3′ are confined in the second gardening ornament frame 2.

The invention is not limited to the above embodiment but various modification thereof may be made. Further, various changes in form and detail may be made without departing from the scope of the invention.

I claim:

1. A gardening ornament frame comprises:
a first half netting,
a second half netting engaging with the first half netting,
a first hollow leg disposed on a bottom of the first half netting,
a second hollow leg disposed on a bottom of the second half netting,
the first half netting having a first periphery, the second half netting having a second periphery,
the first hollow leg having a first bottom opening, and
the second hollow leg having a second bottom opening.
